(19) United States
(12) Patent Application Publication
(10) Pub. No.: US 2010/0138156 A1
(43) Pub. Date: Jun. 3, 2010

(54) User Interactive GPS Locating Device

(76) Inventor: Bertrand Rubin-de-Cervens, East Islip, NY (US)

Correspondence Address: HOFFMANN & BARON, LLP, 6900 JERICHO TURNPIKE, SYOSSET, NY, 11791, US

(21) Appl. No.: 12/628,919

(22) Filed: Dec. 1, 2009

Related U.S. Application Data
(60) Provisional application No. 61/118,774, filed on Dec. 1, 2008.

(51) Int. Cl. G01C 21/00

(52) U.S. Cl. 701/213

(57) ABSTRACT

According to aspects described herein, there is disclosed a method of providing location information for use with a global positioning system. The method includes outputting a locating query for entry of a pair of location codes. Each location code includes no more than 5 alphanumeric characters. Also, each location code is a number based on a numbering system using a value greater than 10 to determine place value. The method also includes translating the location codes into first location information for use with a global positioning system. The first location information includes geographic location identification, an address for the geographic location, directions to the geographic location and/or immediate routing information representing at least a portion of the directions. The method also includes outputting the first location information to a user.

### CROSS-REFERENCE TO RELATED APPLICATIONS

This application claims the benefit of U.S. Provisional Patent Application Ser. No. 61/118,774 filed on Dec. 1, 2008.

### TECHNICAL FIELD

The presently disclosed technologies are directed to devices, systems and methods providing global positioning information interactively to a user; and particularly to a global positioning system interactive with a user for providing location information.

### BACKGROUND OF THE INVENTION

Every location on the planet has a particular coordinate point, defined by a latitude and longitude point. Global positioning system (GPS) units are now used and understood by many people and provides much convenience in locating friend's homes, ports of call, airports, an other common locations. It is generally understood that GPS units use a relatively accurate worldwide navigational and surveying facility based on the reception of signals from an array of orbiting satellites.

Contemporary systems require a user to enter a street address, town, and state, and hope that this can be found. For some, after reading a manual, they will fumble through the instructions, menus, enter data, and perhaps finally enter the appropriate information in order for the GPS unit to comprehend the destination that they are looking for. Finally the GPS unit will search its data base and offer possible choices. So, how long did that take? Has the correct location actually been entered? Is the address 1st street, or First Street, or First Avenue, or 1st Avenue?

People often travel to unfamiliar destinations or regions, renting a car equipped with a GPS unit. When the GPS unit prompts an individual for a city, the names of streets and landmarks may all seem similar, which can be confusing. Similarly, the region may use a different language or dialect, making the unit difficult to use. Or the name may be difficult to distinguish; for example is it Los Grande, Las Grande, Grande, LasGrande, LosGrande. Making matters worse, the wrong name could be hundred of miles from the user's intended destination.

Accordingly, it would be desirable to provide a device, system and method using codes and/or at least one or two short series of alphanumeric characters associated with geographic locations, which overcome the shortcoming of the prior art.

### SUMMARY OF THE INVENTION

According to aspects described herein, there is disclosed a method of providing location information for use with a global positioning system. The method includes outputting a locating query for entry of a pair of location codes. Each location code includes no more than 5 alphanumeric characters. Also, each location code is a number based on a numbering system using a value greater than 10 to determine place value. The method also includes translating the location codes into first location information for use with a global positioning system. The first location information includes geographic location identification, an address for the geographic location, directions to the geographic location and/or immediate routing information representing at least a portion of the directions. The method also includes outputting the first location information to a user.

Additionally, the translation can include converting each location code into a base 10 numbering system number, wherein at least one digit of the base 10 number identifies one of at least two geographic compass directions. The at least two geographic compass directions can be opposed directions. Also, at least two different digits of the base 10 number can identify at least one of degrees, minutes and seconds of a geographic latitude or longitude designation. Further, at least four different digits of the base 10 number can each represent a different one of the compass direction, degrees, minutes and seconds of a geographic latitude or longitude designation.

The method can also include outputting a storage query for receiving second location information, wherein the second location information includes additional details associated with the location. Also, the method can store the second location information, whereby the first and second location information are linked for expediting future access or retrieval. The second location information can be stored in a name lookup for providing location codes in response to a user accessing the name look up. The location codes can be received in response to the locating query after a user accesses a name look up, wherein the name look up provides the location codes.

The method can further include outputting second location information, including a name associated with the first location information. Each location code can use a base 36 numbering system, wherein the base 36 numbering system includes at least 36 different alphanumeric characters.

According to further aspects described herein, there is disclosed a method including outputting a location conversion query for entry of first location information. The first location information includes a latitude address and a longitude address, wherein the latitude and longitude addresses include at least one compass direction and measurements in degrees, minutes and seconds. The method also includes translating the latitude and longitude addresses into a pair of location codes, wherein each location code includes no more than 5 alphanumeric characters. Each location code being a number based on a numbering system using a value greater than 10 to determine place value. The method additionally including outputting the location codes to a user.

Additionally, the translation can include combining each of the latitude and longitude addresses into a single base 10 numbering system number, wherein whole numbers representing the measurements in degrees, minutes and seconds are consecutively ordered in different digits of each respective base 10 number. A digit of each base 10 number can represent one of at least two geographic compass directions. At least two different digits of each base 10 number can identify at least one of degrees, minutes and seconds of a geographic latitude or longitude designation.

The method can further include outputting a storage query for receiving second location information, wherein the second location information includes additional details associated with the location. Also, the second location information can be stored along with the first location information and the location codes, thereby being linked for expediting future access or retrieval. The second location information can be stored in a name lookup for providing location codes in response to a user accessing the name look up. Also, each location code can be selected from a base 36 numbering system, wherein the base 36 numbering system includes at least 36 different alphanumeric characters. The first location information can be received in response to the location conversion query after a user accesses a name look up, wherein the name look up provides the first location information.

The presently disclosed technologies can include a method and system that uses a BAZ code in order to facilitate user interaction with a GPS coordinate system, such as those used in motor vehicles. A BAZ code is a location code as defined herein that represents a latitude-longitude and/or a unique location on the planet Earth. The BAZ code is used in conjunction with a portable GPS unit made to be compatible with BAZ codes. The BAZ code format can be used to enter data in the GPS unit or can be output by the BAZ-compatible GPS unit for the user.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIG. 1 shows a latitude/longitude to BAZ code conversion input screen.

FIG. 2 shows a BAZ Code entry screen for a GPS Unit.

FIG. 3 shows a BAZ Code application entry flow diagram.

FIG. 4 shows a flow diagram for associating a name with BAZ codes.

FIG. 5 shows a BAZ Code retrieval and storage dialogue screen.

### DETAILED DESCRIPTION OF THE PREFERRED EMBODIMENTS

Describing now in further detail these exemplary embodiments with reference to the Figures. In accordance with aspects of the technologies disclosed herein, apparatus, systems and methods are disclosed for providing location information for use with a GPS system. In accordance with an aspect of the disclosed technologies, one or two location codes (each of such codes also referred to and used interchangeably herein as a “BAZ code”) use a coded GPS coordinate (latitude, longitude), for precise locations or destinations. In this way, when a user is traveling, he/she can be provided with a pair of destination BAZ codes in order to more easily find the location and directions to the destination using aspects of the methods and systems of the present invention. A user can be presented with a locating query in the form of a BAZ code entry screen. The user can then enter the BAZ codes on the screen, which can be incorporated into a GPS type portable navigation unit. Preferably the combined pair of BAZ codes are a simple 10 digit (or less) alphanumeric code. Separately, each of the pair of BAZ codes can each comprise a 5 digit (or less) number represented by alphanumeric characters. As used herein the term “alphanumeric” means consisting of letters and/or numbers. For example, alphanumeric characters can include the letters and numbers found on a typical computer keyboard used in English speaking countries. However, it should be understood that alphanumeric characters from other languages could be used as appropriate and desired for the particular user application. These location codes are then translated into a precise longitude-latitude point that corresponds to the destination of travel. Preliminary information regarding the translated codes, such as the destination of travel, can be considered first location information. Such first location information can identify a geographic location, provide a street address for the geographic location, provide directions to the location, plot a path from your current location to your destination or even just portions of the path. The portions of the path can include immediate routing information, such as the very next turn or navigational instructions needed to follow the path or directions. For example, the immediate routing information can indicate “turn left ahead,” provide a left turn signal or include more elaborate routing information.

A BAZ code is a code representing a latitude and longitude point, generated in such a way that it will be a simple alphanumeric code entered into a system. The code could then be further used to look up an address, or if the system becomes widely accepted, can be used directly as a lookup into a database that will present further information. A position is defined by latitude and longitude preferably has the form of degrees, minutes, seconds, shown as a value from +90 degrees to −90 degrees North\South, and from +180 degrees to −180 degrees East\West. These positions can be obtained virtually any azimuth point on the planet. A typical form follows:
Degrees, Minutes, Seconds North\South,
   By
Degrees, Minutes, Seconds, East\West.

Alternatively, the degrees, minutes, seconds can be represented by a single number including three or more decimal places. The more decimal places used, the smaller region is defined, which translates to more accurate location identification. This alternative would take the form as follows:
Degrees (i.e.,)+47.126° North\South, by
Degrees (i.e.,)−120.435° East\West.

When using the format that uses degrees, minutes and seconds, one second represents approximately 100 feet. Preferably, for purposes of locating a building, facility or landmark, 100 is adequate. Similarly, using degrees only with at least four decimal places (i.e.,)0.0167° provides a similar accuracy. However, it should be understood that a more or less refined locating region could be used, depending on the application or desired of the user.

The BAZ code preferably uses a base 36 number system, allowing the full use of the alphabet, and numbers 0-9, in order to translate the azimuth values to a simple alphanumeric code. The rational for this use, is to provide a simple code (like a zip code) that is easy for a user to remember or enter and readily translates to a precise geographic location. Other bases of higher order may be used to compress the end content of the BAZ code to have fewer digits, and also to encrypt additional information. This information may include Name, address, phone number and similar pertinent information relating to the address being located by the application. Alternatively, other bases of lower order could be used, as appropriate for the application or for ease of use by end users.

Preferably, the BAZ code uses Base 36, which is defined as follows:
0=0 1=1 2=2 3=3 4=4 5=5 6=6 7=7 8=8 9=9
10=A 11=B 12=C 13=D 14=E 15=F 16=G 17=H 18=I 19=J
20=K 21=L 22=M 23=N 24=O 25=P 26=Q 27=R 28=S 29=T
30=U 31=V 32=W 33=X 34=Y 35=Z

Using the above translation, degrees, minutes and seconds are combined to form a string version of the numbers. Thus, the degrees, minutes and seconds (represented by whole numbers) are consecutively strung together in series to form a single base 10 numbering system number (a base 10 number). The following is an example of a preliminary longitude conversion:
123 deg 25 min 10 sec =1232510 (A).

Additionally, a geographic compass direction value can be further strung together to the preliminary conversion. This can be done using the following conversion:
N: Defines North —coded with 1000000
S: Defines South —coded with 2000000
E: Defines East —coded with 10000000
W: Defines West —coded with 20000000
   Adding or further stringing together a direction to the example (A) above (i.e., 1232510), is done as follows:
1232510+10000000 (EAST)=11232510 (B).

In this way, each of the digits in the value at (B) relate to, identify and represent the compass direction, degrees minutes and seconds of a geographic location. Then the value at (B) above is converted to base 36, giving a 5 digit alphanumeric code as follows:
BAZ Code Longitude=7GYDU (C).

This method is then repeated for the latitude value, for example as follows:
12 deg 20 min 13 sec=122013
122013+1000000 (NORTH)=1122013
1122013 converted to base 36 gives:
BAZ Code Latitude=Q5WI (D).

Accordingly, the pair of BAZ Codes identifies a unique location as:
BAZ Code Latitude; BAZ Code Longitude
Q5WI, 7GYDU

Like a ten-digit telephone number, a pair of BAZ codes is relatively easy to remember. Additionally, a BAZ code pair could be listed in phone books or other address listings, and cross referenced to correlate to an actual address. A home or business location, would be able to provide its address and telephone number, zip code, as well as a BAZ code. Further, current GPS systems, web sites, or other lookup devices, could make use of BAZ codes. In a preferred embodiment, a GPS unit capable of using a BAZ code is provided. Such a BAZ-GPS unit can be used in motor vehicles, marine vehicles and other portable applications.

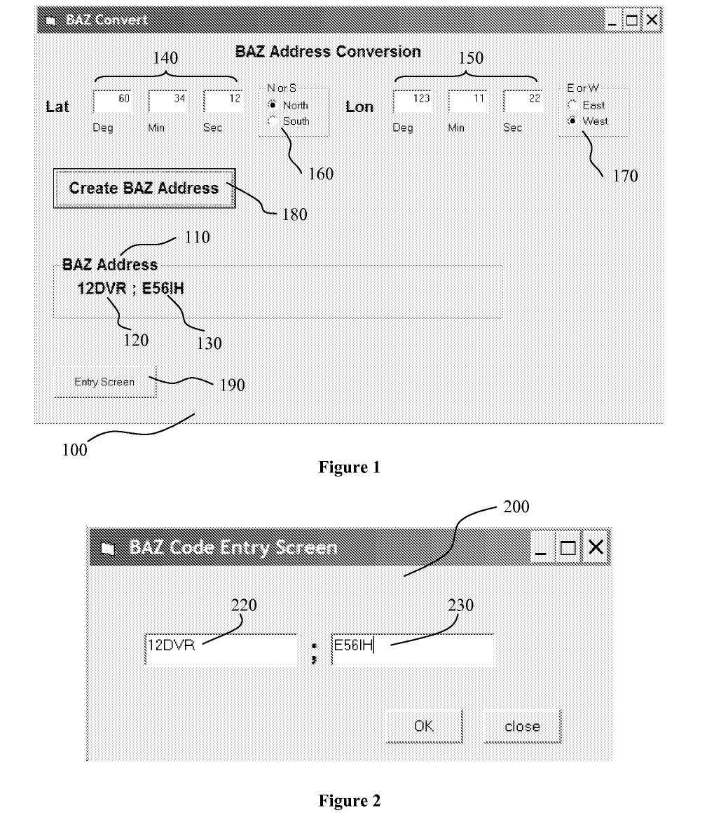

FIG. 1 shows a latitude/longitude to BAZ code conversion input screen 100. The BAZ code conversion fields 140, 150 present a location conversion query to a user. This location conversion query presents a question to the user, in the form of a field or pair of fields (as shown) for entering longitude and latitude information. The user then fills-in the fields 140, 150 in the ‘BAZ Address Conversion Screen’ 100 in order to generate and/or determine the equivalent BAZ code. Such a look-up screen 100 is preferably provided in conjunction with other contemporary GPS unit functions. Such a screen 100 or similar input fields can be provided for a user to convert the traditional and somewhat cumbersome latitude/longitude coordinates into a BAZ Address 110 that includes pair of BAZ codes 120, 130. A user simply enters the degrees (Deg), minutes (Min), and seconds (Sec) in both the latitude (Lat) and longitude (Lon) fields 140, 150, as well as selecting the appropriate North/South 160 and East/West 170 by using the radio buttons. Once the all fields are complete, the user selects the ‘Create BAZ Address’ field 180 and the translation system will generate a pair of BAZ codes 120, 130, which are displayed in the ‘BAZ Address’ field 110. The system can be designed with default settings for how to handle blank fields (such as providing a user pop-up screen or flashing the blank field to indicate a required field has been left blank). Additionally, other navigation buttons, such as the ‘Entry Screen’ button 190, can be provided to use other features of the BAZ-GPS unit.

FIG. 2 shows a BAZ Code entry screen 200 for a BAZ-GPS Unit. A user will operated their BAZ-GPS unit from a main screen. Preferably, the user is given a choice of using a contemporary address system (i.e., an address, city, state or zip code) or a BAZ code system. FIG. 2 then assumes the user has selected to use a BAZ code system. A defined address or location point, is preferably provided with a pair of BAZ code entry fields 220, 230. The BAZ code entry fields 220, 230 present a locating query to a user. This locating query presents a question to the user, in the form of a field or pair of fields (as shown) for entering BAZ codes. The user then fills-in the fields 220, 230 in the ‘BAZ Code Entry Screen’ 200 in order to translate the alphanumeric codes into a specific location. Preferably, the device either includes a database or has access to one through a computer or telecommunications network in order to further translate the location to a street address. However, even if the BAZ Code pair does not correspond to a specific address, it will correspond to a latitude/longitude point or area on the planet.

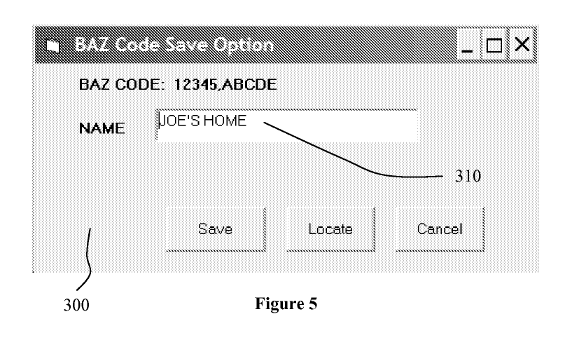

An aspect of the BAZ code is to simplify data entry for an un-savvy user in order to allow them to utilize the capabilities that they already have at hand. The conversion algorithm to provide a BAZ code may be incorporated into a mapping application or one that provided directions, such as those used in personal computers. Once the BAZ code pair is known, it can be stored in an address book along with labels or associations, such as “home,” “work,” “park,” etc., as shown in FIG. 5.

FIG. 5 includes a BAZ Code Save Option screen 300. The BAZ code name field 310 present a storage query to a user. This storage query presents a question to the user, in the form of a field (as shown) for entering a name to be associated with a location. In this way, the Save Option screen 300 includes a name field 310 for entry of a name the user wishes associated with a pair of BAZ codes. This screen 300 can include a display of the BAZ codes as well as additional location information. Also, the BAZ codes can be shared with others in order for them to more easily find a location. This additional information that is associated with a location is also referred to herein as second location information. Such second location information can include a name (full name, nickname or other) or other information associated with an individual or entity related to the location.

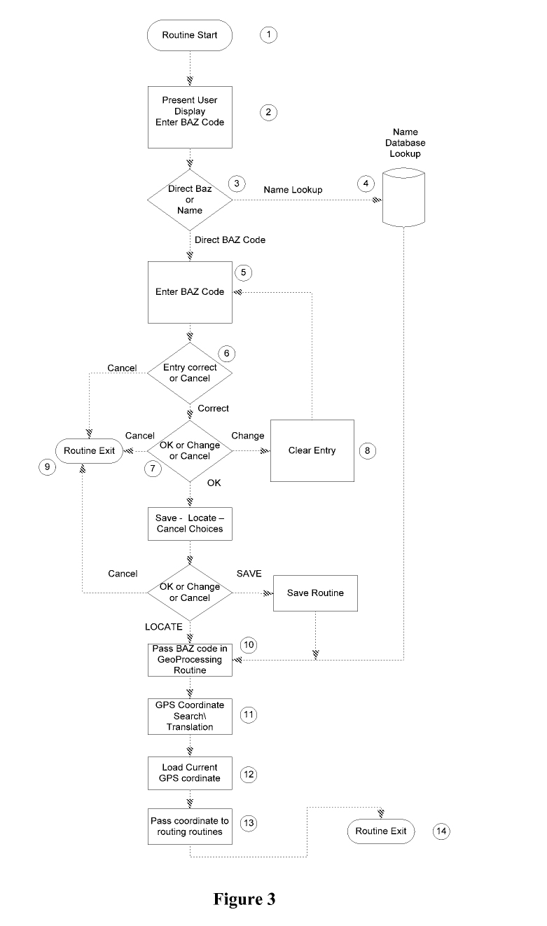

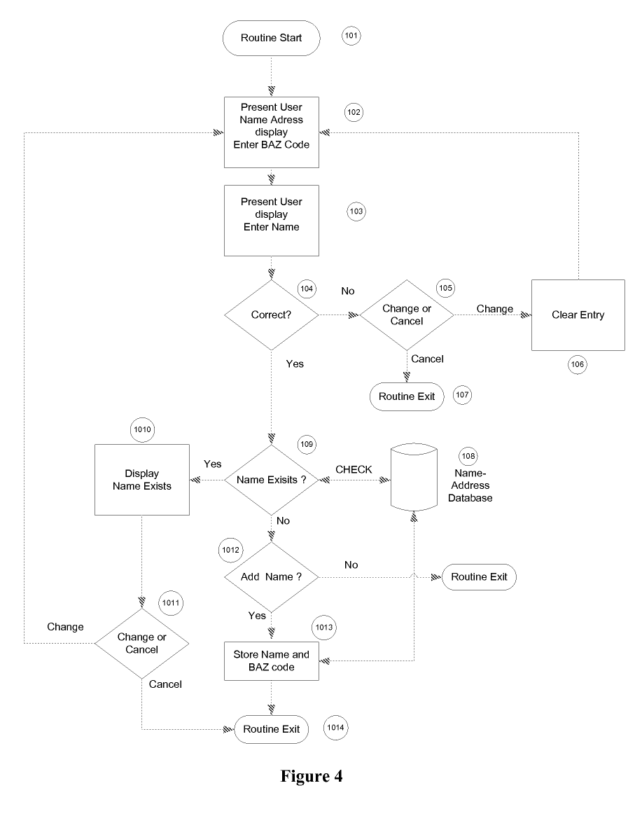

FIG. 3 shows a flow diagram in accordance with the present invention. Once a user elects to use a BAZ code data entry system, the process starts at step 1. Then in step 2, the user is presented the BAZ code entry screen, such as that shown in FIG. 2. In step 3, the user is given the option of choosing to either select a previously saved BAZ code, or to enter a BAZ code directly. If the user selects a saved BAZ code (saved under a name) at step 4, it allows the user to skip to step 10. More detail regarding the steps that preferably take place during step 4, see the description of FIG. 4 below. Otherwise, the user has selected to enter a BAZ code directly in step 5. A screen similar to that shown in FIG. 2 is preferably presented. The code entered could have an option of being saved automatically at this point in the name database or not. Then in step 6, the user is given the option of canceling or correcting the entry. Thus, the user can choose exiting this entire area and return back to the main screen of the unit. Confirmation or change, in order to correct the entry can be performed in step 7. Preferably, such a confirmation screen can include the features shown in FIG. 2. Thus, once the user has selected “OK,” another dialog is presented, as shown in FIG. 5, which allows the users to save this BAZ code associated with a name. If “Save” is chosen, the data uses the routine as shown in FIG. 4 to save the information. Once saved, the user can then proceed to the GPS locating function by selecting “Locate,” as shown in FIG. 5. The BAZ code is then processed, as indicated in step 10 of FIG. 3, through the computer processor using a GeoProcessing Routine, steps 11 through 13. Preferably, the GeoProcessing Routine involves the conversion of global latitude-longitude values, in conjunction with an indexed map, and correlating or pin-pointing a location on the map. It should be understood that the indexing or even the details of the map can be more or less refined in regions of the globe that are appropriate to the application. In steps 11, 12 and 13, the BAZ code is used to pin-point a location. The routine preferably then exits and returns to normal home screen of unit or provides route or map detail, in step 14.

The user at this point has simply entered a BAZ code, without knowing anything other than the code, and has pinpointed a direction, an address, or a route to a destination. There is no need to have to know if they are in a particular county, state, or country.

FIG. 4 expands upon step 4 from FIG. 3. This is where the selection for type of entry would like to use a name look up vs. code entry: The save routine starts at step 101. The user is shown name entry display, at step 102. The user enters the name to save the BAZ CODE, and associated name, at step 103. A check by the user about the entry is requested, at step 104. If the entry needs to be cleared, step 105, it is passes to step 6 and it returns to step 2, an option to exit is given, going to step 7. The user approves entry and a check is made to see if the name entry can be found, step 109. An indication is provided if the name exists already, pint 1010. A check is done if there is a name change to be made of to cancel this dialog, step 1011. If the user wants to add a name, a check is done at step 1012. The user can then store the name into the memory or database, step 1013. Finally the routine returns back to the calling screen, step 1014.

It is understood that the systems, functions, methods, steps and calculations described herein can be implemented in hardware, software, or a combination of hardware and software. They may be implemented by any type of computer system or other apparatus adapted for carrying out the methods described herein. A typical combination of hardware and software could be a portable GPS device or a more general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present methods can also be embedded in a computer program product or computer-readable medium, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form. The term computer readable medium is any data storage device that can store data, which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

Thus, while the preferred embodiments of the present invention have been described with reference to the accompanying drawings, it is to be understood that the invention is not limited to those precise embodiments and that various other changes and modifications to the invention may be affected by one skilled in the art without departing from the scope or spirit of the invention, and that it is intended to claim all such changes and modifications that fall within the scope of the invention.

What is claimed:

1. A method of providing location information for use with a global positioning system, the method comprising:
outputting a locating query for entry of a pair of location codes, wherein each location code includes no more than 5 alphanumeric characters, each location code being a number based on a numbering system using a value greater than 10 to determine place value;
translating the location codes into first location information for use with a global positioning system, wherein the first location information includes at least one of a geographic location identification, an address for the geographic location, directions to the geographic location and immediate routing information representing at least a portion of the directions; and
outputting the first location information to a user.

2. The method of claim 1, wherein the translation includes converting each location code into a base 10 numbering system number, wherein at least one digit of the base 10 number identifies one of at least two geographic compass directions.

3. The method of claim 2, wherein the at least two geographic compass directions are opposed directions.

4. The method of claim 2, wherein at least two different digits of the base 10 number identify at least one of degrees, minutes and seconds of a geographic latitude or longitude designation.

5. The method of claim 2, wherein at least four different digits of the base 10 number each represent a different one of the compass direction, degrees, minutes and seconds of a geographic latitude or longitude designation.

6. The method of claim 1, further comprising:
outputting a storage query for receiving second location information, wherein the second location information includes additional details associated with the location; and
storing the second location information whereby the first and second location information are linked for expediting future access or retrieval.

7. The method of claim 6, wherein the second location information is stored in a name lookup for providing location codes in response to a user accessing the name look up.

8. The method of claim 1, wherein the location codes are received in response to the locating query after a user accesses a name look up, wherein the name look up provides the location codes.

9. The method of claim 1, further comprising:
outputting second location information including a name associated with the first location information.

10. The method of claim 1, wherein each location code uses a base 36 numbering system, wherein the base 36 numbering system includes at least 36 different alphanumeric characters.

11. A method of providing location information for use with a global positioning system, the method comprising:
outputting a location conversion query for entry of first location information, wherein the first location information includes a latitude address and a longitude address, wherein the latitude and longitude addresses include at least one compass direction and measurements in degrees, minutes and seconds;
translating the latitude and longitude addresses into a pair of location codes, wherein each location code includes no more than 5 alphanumeric characters, each location code being a number based on a numbering system using a value greater than 10 to determine place value; and
outputting the location codes to a user.

12. The method of claim 11, wherein the translation includes combining each of the latitude and longitude addresses into a single base 10 numbering system number, wherein whole numbers representing the measurements in degrees, minutes and seconds are consecutively ordered in different digits of each respective base 10 number.

13. The method of claim 12, wherein a digit of each base 10 number represents one of at least two geographic compass directions.

14. The method of claim 13, wherein at least two different digits of each base 10 number identify at least one of degrees, minutes and seconds of a geographic latitude or longitude designation.

15. The method of claim 11, further comprising:
outputting a storage query for receiving second location information, wherein the second location information includes additional details associated with the location; and
storing the second location information whereby the first location information, the second location information and the location codes are linked for expediting future access or retrieval.

16. The method of claim 15, wherein the second location information is stored in a name lookup for providing location codes in response to a user accessing the name look up.

17. The method of claim 11, wherein each location code is selected from a base 36 numbering system, wherein the base 36 numbering system includes at least 36 different alphanumeric characters.

18. The method of claim 11, wherein the first location information is received in response to the location conversion query after a user accesses a name look up, wherein the name look up provides the first location information.
